(19) United States
(12) Patent Application Publication
(10) Pub. No.: US 2017/0236669 A1
(43) Pub. Date: Aug. 17, 2017

(54) Bistable Relay

(71) Applicant: Telepath Networks, Inc., Frederick, MD (US)

(72) Inventor: Robert Tarzwell, Chatsworth (CA)

(73) Assignee: Telepath Networks, Inc., Frederick, MD (US)

(21) Appl. No.: 15/081,624

(22) Filed: Mar. 25, 2016

Related U.S. Application Data
(60) Provisional application No. 62/296,079, filed on Feb. 17, 2016.

(51) Int. Cl. H01H 50/04; H01H 50/14; H01H 49/00; H01H 50/10

(52) U.S. Cl. CPC H01H 50/04; H01H 50/10; H01H 50/14; H01H 49/00

(57) ABSTRACT

A reed switch is positioned within a housing and an actuation or drive coil is wrapped around a central portion of the housing. A permanent magnet for biasing or holding the reed switch contact in a closed positioned is mounted in the housing outside of and spaced apart from the coil and in direct mechanical contact with a bare uninsulated portion of one of the reed switch leads.

### CROSS REFERENCE TO RELATED APPLICATIONS

This application claims the benefit of and priority to U.S. Provisional Patent Application No. 62/296,079, filed Feb. 17, 2016, and entitled, “Bistable Relay,” the contents of which is incorporated herein by this reference in its entirety.

### FIELD OF THE DISCLOSURE

The subject disclosure relates to electronic relays and switches, and more particularly to bistable reed switch relays.

### DESCRIPTION OF RELATED ART

Various bistable reed switch relays have been constructed in the past.

### SUMMARY

Illustrative relay embodiments contemplate a relay comprising a reed switch positioned within an actuation or drive coil and a permanent magnet for biasing or holding the reed switch contact closed where the permanent magnet is positioned outside of and spaced apart from the actuation or drive coil and in contact with an input or output lead of the reed switch.

In a first illustrative embodiment, a relay is provided comprising a housing having a central portion wherein first and second reed switches are positioned. An electrically conductive coil is wrapped around the central portion of the housing. First and second input leads of the respective first and second reed switches enter the housing at a first end thereof and are connected to supply respective input signals to the first and second reed switches. In the first illustrative embodiment, each of the first and second input leads comprises a material which transfers magnetic energy.

Further according the first illustrative embodiment, first and second permanent magnets are mounted at the first end of the housing so as to directly contact a respective one of the first and second reed switch input leads at a point prior to those leads entering the housing. The first and second permanent magnets each have a strength selected to hold a respective reed switch relay contact of each of the first and second reed switches closed after supply of drive current to the electrically conductive coil has initially caused those respective relay contacts to close.

Other embodiments may comprise a similar structure wherein only a single reed relay switch and a single permanent magnet are employed or may comprise a similar structure wherein more than two reed relay switches are employed. Embodiments may be constructed wherein the output leads of the reed switches exit at an opposite end of the housing or at the same end as the input leads. Various embodiments are configured to operate as bistable reed switch relays. While illustrative embodiments described below place a permanent magnet or magnets in direct contact with the reed switch input lead or leads, other embodiments may be configured where the permanent magnet(s) directly contact the reed switch output lead or leads.

The illustrative embodiments further contemplate a method of making a relay comprising positioning a reed switch in a housing with an input lead and an output of the reed switch extending outside of the housing; wrapping an actuating coil around the housing; positioning a permanent magnet outside the housing, spaced apart from the actuating coil, and directly mechanically contacting one of the input or output leads of the reed switch and, prior to the step of positioning the permanent magnet outside the housing and in contact with a reed switch lead, selecting the strength of the permanent magnet to hold a contact of the reed switch closed after that contact has been initially closed.

### DESCRIPTION OF THE DRAWINGS

FIG. 1 is a perspective view of an illustrative embodiment of a bistable reed switch relay;

FIG. 2 is a side view of the relay of FIG. 1;

FIG. 3 is a sectional view taken at III-III of FIG. 1;

FIG. 4 is perspective view of a second bistable reed switch relay embodiment in a partially assembled state;

FIG. 5 is a side view of the relay of FIG. 4;

FIG. 6 is an end view of a first end of the relay of FIG. 4;

FIG. 7 is an end view of the second end of the relay of FIG. 4;

FIG. 8 is a sectional view taken at VIII-VIII of FIG. 5;

FIG. 9 is a sectional view taken at IX-IX of FIG. 5;

FIG. 10 is a perspective view of a magnetic shield embodiment; and

FIG. 11 is a side sectional view illustrating the shield installed on a printed circuit board around a bistable reed switch.

### DETAILED DESCRIPTION OF THE ILLUSTRATIVE EMBODIMENTS

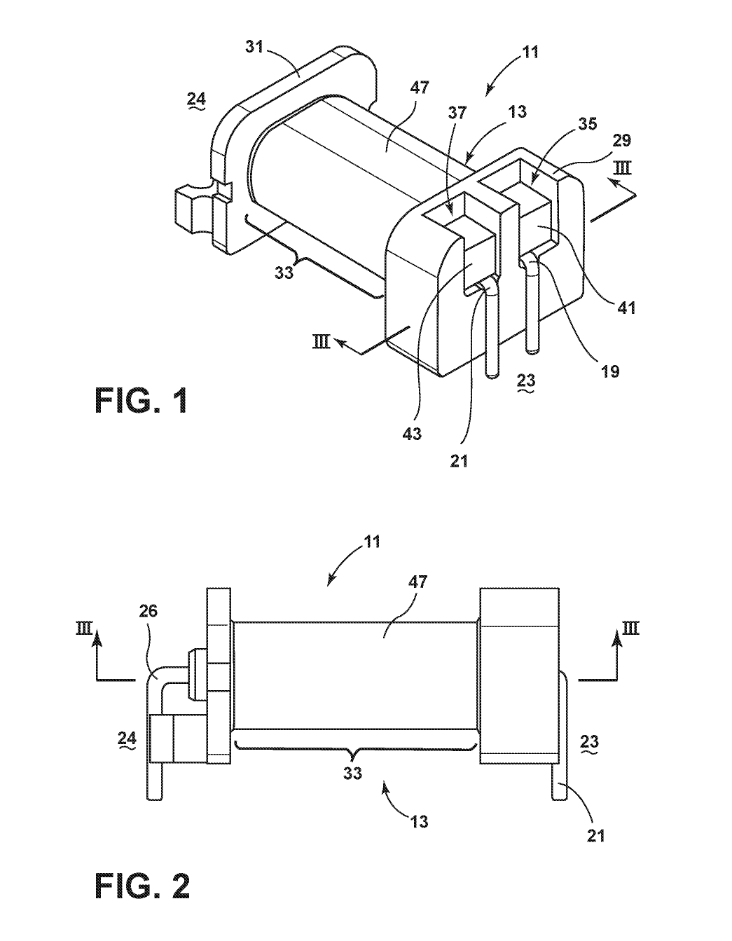

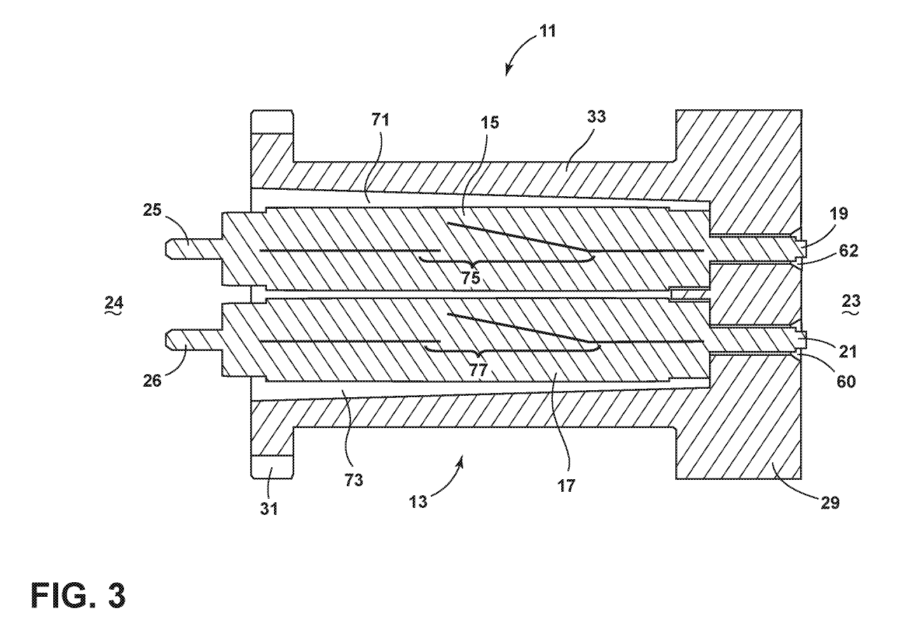

FIGS. 1-3 show an illustrative embodiment of a bistable reed switch relay 11 comprising a housing 13, which, in illustrative embodiments, may be formed of molded plastic material. In one embodiment, the plastic can be reinforced for strength with glass or carbon fibers, microbeads, or filaments, which may be fiberglass like. Within the housing 13 are mounted two reed switches 15, 17 (FIG. 3), which, in one embodiment, are positioned in respective cavities 71, 73 by the positioning of respective un-insulated bare iron input leads 19, 21, in respective slots 62, 60 at a first end 23 of the housing 13. In one embodiment, the cavities 71, 73 and slots 60, 62 are molded into the housing 13.

The first and second un-insulated bare iron input leads 19, 21 enter through the first end 23 of the housing 13 and provide respective input signals to the respective reed switches 15, 17. Respective output leads 25, 26 comprise respective output terminals of the reed switches 15, 17 and exit at a second or opposite end 24 of the housing 13. In an illustrative embodiment, the leads 19, 21 may be 0.020 inches in diameter, but of course may have other dimensions in other embodiments.

The housing 13 has a first flange 29 at its first end 23, a second flange 31 at its second end 24, and a central barrel or bobbin 33 located between the flanges 29, 31. The barrel 33 encloses the reed switches 15, 17 and has a conductive coil 47 wrapped around it between the flanges 29, 31, which, in one embodiment, may be formed of insulated copper wire. When supplied with drive current, the conductive coil 47 either opens or closes respective contacts 75, 77 (FIG. 3) of the respective reed switches 15, 17. As those skilled in the art appreciate, the term “contact” refers to the two contact blades which make up the reed switch.

As seen in FIG. 1, the first flange 29 of the relay housing 13 has respective adjacent cavities or wells 35, 37 formed in an upper end thereof. In some embodiments, these wells 35, 37 may be rectangular or square in horizontal cross-section, but may have other shapes in other embodiments. Each well 35, 37 contains a respective permanent magnet 41, 43. In one embodiment, these permanent magnets 41, 43 may be formed of NdFeB Neodymium alloy hard magnetic material and glued or otherwise attached in contact with a respective one of the insulated input leads 19, 21. Other permanent magnetic materials include AlNiCo, SmCo, and ceramic materials formed of Barium or Strontium Ferrite. In the illustrative embodiment, there is direct mechanical contact between the permanent magnetic material of the permanent magnets 41, 43 and the bare iron input leads 19, 21 respectively.

In illustrative embodiments, the input leads 19, 21 must be iron, iron alloy or other magnetic material in order to transfer the magnetic energy required to hold the contacts 75, 77 of the reed switches 15, 17 closed, after a drive pulse to the coil 47 has initially closed them. In some embodiments, increasing the iron concentration in the leads 19, 21 over conventional iron reed switch leads may be employed to enhance performance.

In an alternate embodiment, the conductors 19, 21 could be insulated as opposed to bare uninsulated conductors, but such a construction would typically require larger permanent magnets to achieve the same magnetic strength at the reed switch contacts 75, 77. In an illustrative embodiment, the housing 13 may be a single piece molded part, and the flanges 29, 31 serve to hold the permanent magnets 41, 43 and coil wires in place in the housing 13.

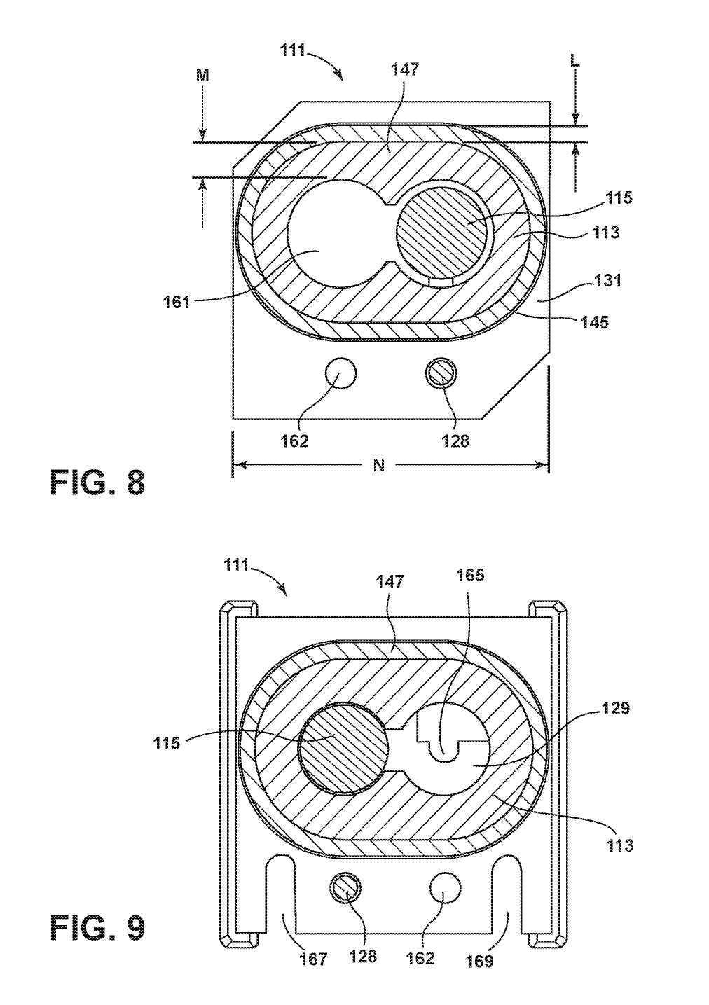

In one illustrative embodiment, the permanent magnets 41, 43 are cubes of quite small dimensions, for example, 0.0625 inch on a side. The permanent magnets 41, 43 may have other shapes and dimensions in other embodiments. The positioning of two small permanent magnets in a dual reed switch embodiment enables wrapping a magnetic shield, e.g. 49, around the relay coils, further reducing any de-magnetization effect that the relay coil 47 might have on the permanent magnets 41, 43. The cross-section of FIG. 8 illustrates such a magnetic shield 145 positioned around a relay actuation coil 147. In one embodiment, the magnetic shield 145 may comprise magnetic shield tape wrapped around the coil 14. In another embodiment, the magnetic shield 145 may comprise a square channel of steel or Mu metal. Such a magnetic shield 145 may also be applied around the core 47 of FIG. 1.

In assembly of one embodiment according to FIGS. 1-3, the actuation coil 47 is wound on to the molded core 33, the reed switches 15, 17 are inserted into the respective openings 71, 73, the permanent magnets 41, 43 are glued in place, and magnetic shield tape is wrapped around the coil 47 and glued or otherwise attached in place.

In operation of the bistable relay 11, the coil 47 first pulses in one direction, creating a magnetic field which closes the reed switch contacts 75, 77. The permanent magnets 41, 43 supply a magnetic field sufficient to keep the reed switch contacts 75, 77 closed while the reed switch coil 47 is off. To open the relay contacts 75, 77, a reverse pulse is applied to the coil 47, temporarily interrupting the permanent magnet magnetic field and allowing the contacts 75, 77 to open.

Various embodiments constructed according to the teachings above can exhibit various advantages. For example, locating a bias magnet, e.g. 41 outside the strong field of the actuation coil 47 and situated directly touching an iron lead, e.g. 19, of a reed switch significantly reduces or eliminates demagnetization of the permanent magnet by the strong coil magnetic field. It is also possible to use a much weaker permanent magnet, allowing closer relay placements. In some applications, the strength of the permanent magnet need only be one-half to one-tenth the power required when permanent magnets are placed inside the actuation coil windings. Additionally, the size of the relay may be much smaller than various existing designs, and the cost may be one fourth that of typical twin circuit bistable reed relays.

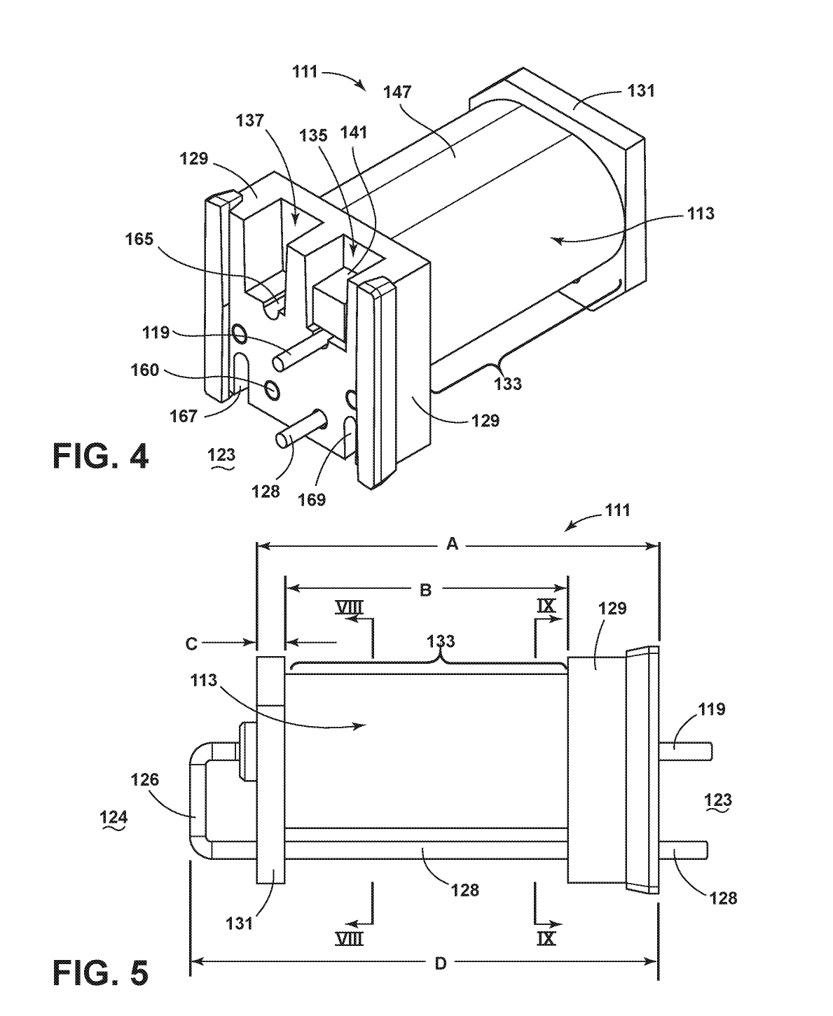

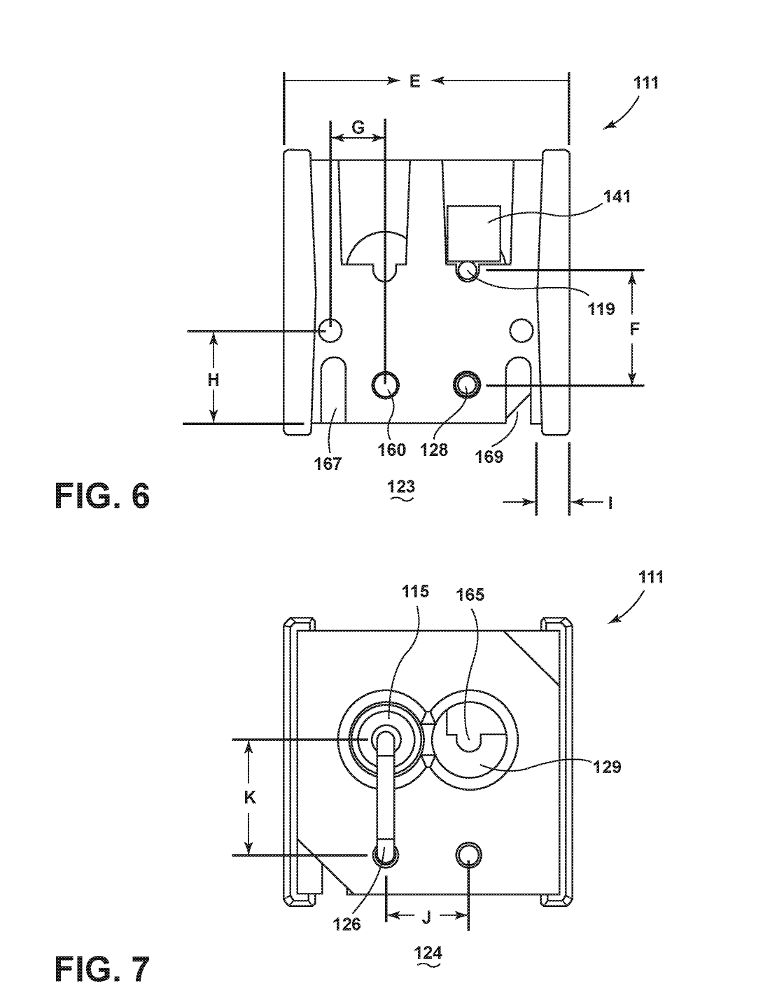

FIGS. 4-9 illustrate an alternate bistable relay embodiment constructed generally as shown in FIGS. 1-3 but wherein the reed switch output leads, e.g. 128, from relay switches, e.g. 115, exit from the same end 123 of the bistable reed switch 111. For illustrative purposes, only a first of the reed switches 115 is shown installed in the housing 113 of the device 111. Thus, FIGS. 4-9 show the opening 160 of circular cross-section which receives the output lead of the uninstalled relay switch, as well as a semicircular trough 165, which receives the bare input iron lead of that uninstalled switch. FIG. 5 illustrates that the reed switch output leads, e.g., 126 bend 180 degrees into linear segment 128, which passes through flanges 131, 129 and beneath the barrel portion 133 of the housing 111. In one embodiment, a lead bending machine may be employed to impart two ninety degree bends in a one piece continuous straight lead wire to achieve the configuration of FIG. 5. Openings 167, 169 (FIG. 4) accommodate leads which supply actuation or drive current to the central coil 147

Illustrative dimensions in inches for one illustrative embodiment of a relay according to FIGS. 4-9 are A=0.427, B=0.300, C=0.030, D=0.498, E=0.260, F=0.105, G=0.050, H=0.085, I=0.030, J=0.075 and K=0.105. Various dimensions of course may be used in other embodiments.

Alternate embodiments may be constructed according the principles disclosed above—for example, an embodiment which employs a single reed switch as opposed to two or more than two. Thus, illustrative embodiments may comprise at least one reed switch. As discussed in connection with FIGS. 4-9, in other embodiments, all leads, i.e., input and output leads, may exit the same end of the device. In some such embodiments, the device may be configured to occupy a “stand-up” position.

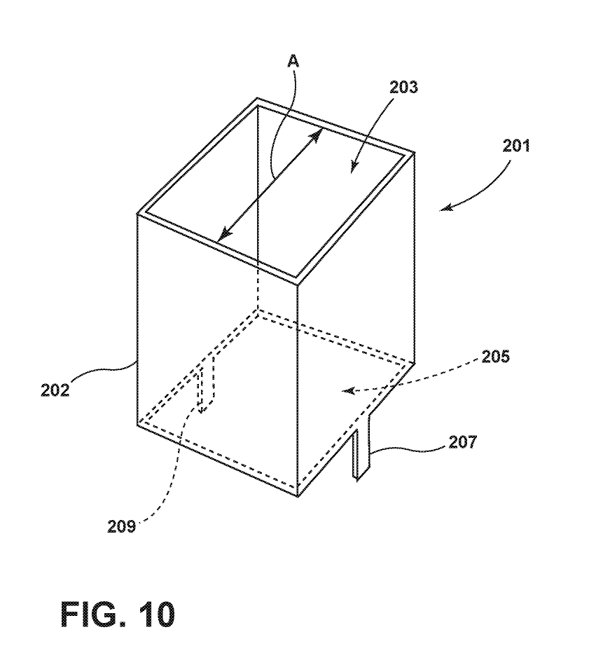

FIG. 10 illustrates an embodiment of a magnetic shield 201. In one embodiment, the shield 201 is tube 202 having rectangular sides and a square cross-section “A,” which is open at both ends 203, 205. The tube 202 could have other cross-sectional shapes in other embodiments.

In one embodiment, the tube 202 may be formed of tin-plated steel but may constructed of other suitable magnetic material in other embodiments, for example, such as mu metal. In the embodiment of FIG. 10, the tube 202 has first and second downwardly vertically extending electrical contact pins 207, 209, which may be unitarily formed as part of the tube 202, for example, by die cutting the pins 207, 209 out of the same metal from which the tube 201 is formed. In one embodiment, each of the pins 207, 209 is connected to ground.

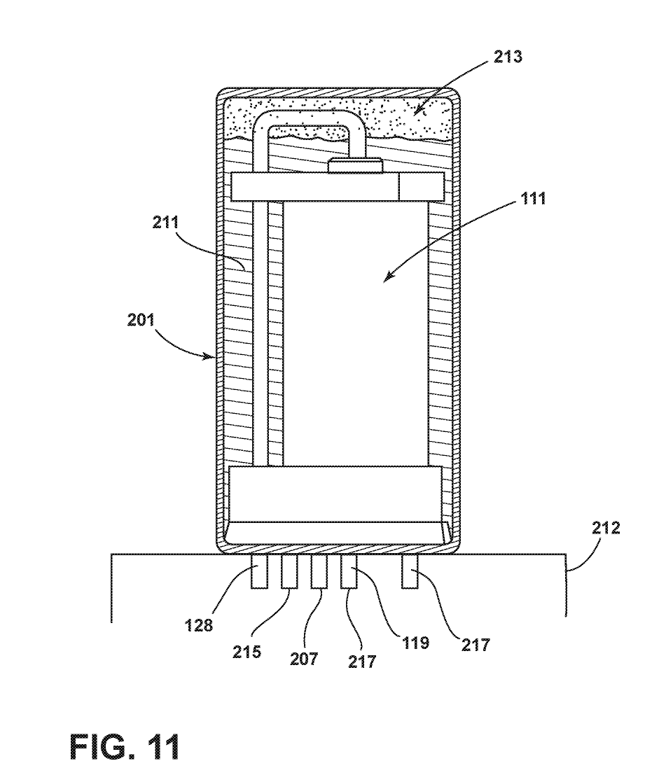

FIG. 11 illustrates the shield 201 installed around a bistable relay, in this case the bistable relay switch embodiment 111 of FIG. 4. In one such embodiment, the space 211 between the relay switch 111 and the shield 201 may be filled with epoxy, and the top opening 203 may be filled with glue to glue the shield 201 to the relay 111 and seal the top opening 203.

As a result of the construction shown in FIG. 11, there are eight conductor pins extending vertically downward, which may be soldered to a circuit board 213. These pins include the relay input lead pins, e.g. 119, of each of the reed switches, the relay output lead pins, e.g. 128 of each of the reed switches, the input and output lead pins 215, 217 of the actuation coil 147 and the two pins 207, 209 of the magnetic shield 201.

In various embodiments, the shield structure of FIGS. 10 and 11 allows a bistable relay according to the illustrative and other embodiments to operate at high frequencies. For example, in one embodiment, the shield 201 is tuned by adjusting the spacing of the relay leads and how close those leads are to the metal shield 201 to give the relay a 130 ohm impedance, allowing it to operate at frequencies of up to seven Giga-Hertz. Such a shield structure may be employed with the various relay embodiments described above.

From the foregoing, those skilled in the art will appreciate that various adaptations and modifications of the just described illustrative embodiments can be configured without departing from the scope and spirit of the invention. Therefore, it is to be understood that, within the scope of the appended claims, the invention may be practiced other than as specifically described herein.

What is claimed is:

1. A bistable relay comprising:
a housing having a central portion wherein first and second reed switches are positioned;
an electrically conductive coil wrapped around said central portion;
first and second input leads entering said housing at a first end thereof and connected to supply respective input signals to the first and second reed switches, each of the first and second input leads comprising a material which transfers magnetic energy; and
first and second permanent magnets mounted at the first end of the housing, each permanent magnet directly contacting a respective one of the first and second input leads prior to those leads entering said housing, wherein the first and second permanent magnets each have a strength selected to hold a respective reed switch relay contact of each of the first and second reed switches closed after supply of drive current to said electrically conductive coil has initially caused those respective relay contacts to close.

2. The bistable relay of claim 1 wherein each of said first and second input leads comprises an un-insulated lead.

3. The bistable relay of claim 2 wherein each permanent magnet directly mechanically contacts a respective one of said un-insulated leads.

4. The bistable relay of claim 3 wherein said first and second input leads each comprise bare iron.

5. The bistable relay of claim 1 wherein said central portion is positioned between first and second flanges.

6. The bistable relay of claim 5 wherein the first flange includes respective wells shaped to receive and hold a respective one of the first and second permanent magnets.

7. The bistable relay of claim 1 further comprising a magnetic shield positioned around an outer perimeter of said electrically conductive coil.

8. The bistable relay of claim 1 wherein said housing is a single piece molded part.

9. The bistable relay of claim 8 wherein said single piece molded part has respective first and second cavities for receiving the first and second reed switches and first and second wells shaped to receive and hold said first and second permanent magnets.

10. The bistable relay of claim 1 further comprising a magnetic shield placed around the housing, the shield comprising a metal tube open at one end and having at least a first downwardly extending vertically extending contact pin.

11. The bistable relay of claim 10 wherein input and output pins of the first and second reed switches and input and output pins of said electrically conductive coil all extend from a bottom surface of the relay such that all said input and output pins and said downwardly vertically extending pin may be attached to a surface of a printed circuit board.

12. The bistable relay of claim 10 wherein the shield and relay are tuned to yield an impedance enabling operation of the relay at frequencies up to seven GigaHertz.

13. A bistable relay comprising:
a housing having a central portion wherein at least a first reed switch is positioned;
an electrically conductive coil wrapped around said central portion;
an input lead entering said housing at a first end thereof and connected to supply an input signal to the at least one reed switch, the input lead comprising a material which transfers magnetic energy; and
a permanent magnet mounted at the first end of the housing, the permanent magnet directly contacting the input lead prior to the input lead entering said housing, wherein the permanent magnet has a strength selected to hold a relay contact of the reed switch closed after supply of drive current to said electrically conductive coil has initially caused said contact to close.

14. The bistable relay of claim 10 wherein said input lead comprises an un-insulated lead.

15. The bistable relay of claim 11 wherein said permanent magnet directly mechanically contacts said un-insulated lead.

16. The bistable relay of claim 12 wherein said uninsulated input lead comprises bare iron.

17. A method of making a relay comprising:
positioning a reed switch in a housing with an input lead and an output lead of the reed switch extending outside of a housing;
installing an actuating electrically conductive coil around the housing;
positioning a permanent magnet outside the housing, spaced apart from the actuating coil, and directly mechanically contacting one of the input and ouput leads of the reed switch; and
prior to the step of positioning the permanent magnet outside the housing, selecting the strength of the permanent magnet to be sufficient to hold a contact of the reed switch closed after said contact has been initially closed.

18. The method of claim 14 wherein each of the input and output leads each comprise an un-insulated lead.

19. The method of claim 15 wherein the permanent magnet directly mechanically contacts the un-insulated lead.

20. The method of claim 16 wherein said input and output leads each comprise bare iron.

21. A relay comprising:
a reed switch positioned within an actuation coil; and
a permanent magnet for holding a contact of the reed switch closed, the permanent magnet being positioned outside of and spaced apart from the actuation coil and in contact with an input or output lead of the reed switch.

22. The relay of claim 18 wherein each of the input and output leads comprise an un-insulated lead.

23. The relay of claim 19 wherein the permanent magnet directly mechanically contacts a respective one of said un-insulated leads.

24. The relay of claim 20 wherein each of the input and output leads comprises bare iron.

25. The bistable relay of claim 7 wherein said magnetic shield comprises magnetic shield tape.

26. The bistable relay of claim 22 further comprising a magnetic shield placed around the reed switch, actuation coil, and permanent magnet, the shield comprising a metal tube open at one end and having at least a first downwardly extending vertically extending contact pin.
